(19) United States
(12) Patent Application Publication
(10) Pub. No.: US 2025/0273703 A1
(43) Pub. Date: Aug. 28, 2025

(54) METHOD FOR MANUFACTURING A BIPOLAR PLATE

(71) Applicant: Robert Bosch GmbH, Stuttgart (DE)

(72) Inventor: Florian Postler, Gundelsheim (DE)

(21) Appl. No.: 18/857,552

(22) PCT Filed: May 3, 2023
(86) PCT No.: PCT/EP2023/061590

§ 371 Date: Oct. 17, 2024

(30) Foreign Application Priority Data
May 9, 2022 (DE) 10 2022 204 534.3

(51) Int. Cl. H01M 8/0286

(52) U.S. Cl. CPC H01M 8/0286

(57) ABSTRACT

Method for manufacturing a bipolar plate (10, 51) for an electrochemical cell unit (53) for converting electrochemical energy into electrical energy as a fuel cell unit (1) and/or for converting electrical energy into electrochemical energy as an electrolytic cell unit (49) having stacked electrochemical cells (52), said method comprising the following steps: providing a first plate (64) and a second plate (65); stacking the first plate (64) and the second plate (65), one atop the other, such that inner surfaces (66) of the first and second plates (64, 65) lie one atop the other, and an intermediate space (79) is formed between the first and second plates (64, 65), fluid-tightly sealing the intermediate space (79) with respect to the surroundings using at least one sealing means (84) for preventing the inflow of a fluid from the surroundings into the interior space (79); applying contact forces to the first and/or second plate (64, 65) so that, as a result of the applied contact forces, the inner surfaces (66) of the first and second plates (64, 65) lie, one atop the other, with an additional compressive force in a contact region (68) due to the applied contact forces by applying a negative pressure to the intermediate space (79) relative to an ambient pressure, said negative pressure in the intermediate space (79) causing the contact forces applied to the first and/or second plate (64, 65) to be applied to the first and/or second plate (64, 65) by the ambient pressure; and producing a welded joint (69) between the first and second plate (64, 65), the intermediate space (79) being sealed using at least one film (85) as the at least one sealing means (84).

### BACKGROUND

The present invention relates to a method for manufacturing a bipolar plate for an electrochemical cell unit, a method for manufacturing an electrochemical cell unit, and an electrochemical cell unit according to the disclosure.

Fuel cell units acting as galvanic cells convert continuously supplied fuel and oxidizing agent into electrical energy and water by means of redox reactions at an anode and a cathode. Fuel cells are used in a wide variety of stationary and mobile applications, for example in houses not connected to the electricity grid or in motor vehicles, rail transport, aviation, space travel, and shipping. In fuel cell units, a large number of fuel cells are arranged in a stack.

In fuel cell units, a large number of fuel cells are arranged in a fuel cell stack. Provided inside each fuel is a gas chamber for oxidizing agents, i.e. a flow chamber for conducting oxidizing agents, such as air from the surroundings comprising oxygen. The gas chamber for oxidizing agents is formed by channels on the bipolar plate and by a gas diffusion layer for a cathode. The channels are thus formed by a corresponding channel structure of a bipolar plate and the oxidizing agent, namely oxygen, reaches the cathode of the fuel cells through the gas diffusion layer. Similarly, a gas chamber for fuel is provided.

Electrolytic cell units consisting of stacked electrolytic cells, similar to fuel cell units, are used for, e.g., the electrolytic production of hydrogen and oxygen from water. Furthermore, fuel cell units are known which can be operated as reversible fuel cell units and thus as electrolytic cell units. Fuel cell units and electrolytic cell units form electrochemical cell units. Fuel cells and electrolysis cells form electrochemical cells.

When manufacturing and assembling electrochemical cells, in particular fuel cells, it is necessary to arrange the components of the fuel cells in an aligned stack. The disc-shaped components of the fuel cells are proton exchange membranes, anodes, cathodes, gas diffusion layers, and bipolar plates. An essential component of the stack are the electrically conductive bipolar plates. The latter function as current collectors for water drainage and for the conduction of the reaction gases and liquid or gaseous coolant through flow spaces, in particular channels or channel structures. The bipolar plates lie upon contact surfaces on the gas diffusion layers.

The bipolar plates are generally formed from two or three stainless steel plates. When manufacturing the bipolar plates, a first and second plate are placed, one upon another, and the plates are then welded together to form weld seams. The weld seams not only have the function of connecting the plates to each other in a bonded and electrically conductive manner, but also serve to fluid-tightly seal channels, which are for coolants and are formed between each two plates. For each bipolar plate, a correspondingly wave-shaped first and second plate are placed, one upon the other, and stacked so that the inner surfaces of the first and second plates lie on one another at strip-shaped contact regions and between the inner surfaces there is a gap having a thickness in each of the strip-shaped contact regions. For a reliable and fluid-tight formation of the weld seam, it is necessary that the thickness of the gaps is small, i.e. the gaps form a technical zero gap less than 20 μm. In addition, the first and second plates are stacked, one upon the other, in a correct lateral relative position as a target position, so that the welded joints are only made at the strip-shaped contact regions acting as joining regions.

If the thicknesses of the gaps are large, the weld seams can no longer be produced without interruptions between the first and second plates, so fluids pass horizontally in the direction of the plane of the first and second plates through leaks between the first and second plates. Moreover, fluids may flow vertically and perpendicularly to the plane of the first and second plates along the weld seam due to a seam penetration at a weld seam. Leaks in the weld seams can only be detected later in the production process during leak tests on the fuel cell unit so that, even if just one weld seam leaks in a fuel cell unit comprising, for example 500, then the entire fuel cell unit can no longer be used and must be disposed of. In order to avoid large gaps at the contact regions, i.e. for the formation of technical zero gaps, contact forces are applied to the first and second plates during the welding process using mechanical hold-down devices, so that as a result of the applied contact forces, the inner surfaces of the first and second plate lie on one another with an additional compressive force at a contact region. Due to the additional compressive force, the technical zero gap is formed at the contact regions. However, the mechanical hold-down devices inhibit the formation of the weld seams by means of laser welding because the laser beam is blocked by the mechanical hold-down devices such, that during laser welding, hold-down devices must be constantly released, i.e. deactivated, and others must be placed on the plates, i.e. activated. Therefore, the hold-down devices, e.g. gripping pliers, have to be constantly changed during welding, which is time-consuming. A great deal of time is thus required for forming the welded joint between the first and second plate from a large number of weld seams. Furthermore, there are high costs for the hold-down devices. High costs are thus incurred in the industrial production of the fuel cell unit in large numbers due to the high time expenditure.

DE 10 2008 024 478 B4 discloses a method for generating a bipolar plate assembly for a fuel cell stack, comprising the following steps: providing a first unipolar plate having a first inner surface; providing a second unipolar plate having a second inner surface; positioning the first inner surface adjacent to the second inner surface; and joining the first unipolar plate and the second unipolar plate using a plurality of point electrically conductive nodes, whereby, when the first unipolar plate and the second unipolar plate are joined, the plurality of point electrically conductive nodes are distributed in a uniform 2D grid pattern over the area of a coolant flow field formed in the interior of the bipolar plate assembly, and the step of joining a first peripheral flange of the first unipolar plate with a second peripheral flange of the second unipolar plate is performed using laser welding.

DE 10 2021 206 581 A1 discloses a method for manufacturing a bipolar plate for an electrochemical cell unit, comprising the following steps: providing a first plate and a second plate, stacking the first plate and the second plate, one atop the other, such that inner surfaces of the first and second plate lie, one atop the other, and an intermediate space is formed between the first and second plates; applying contact forces to the first and second plates so that, as a result of the applied contact forces, the inner surfaces of the first and second plates lie, one atop the other with an additional compressive force at a contact region due to the applied contact forces by applying a negative pressure to the intermediate space relative to an ambient pressure, said negative pressure in the intermediate space causing the contact forces applied to the first and/or second plate to be applied to the first and/or second plate by the ambient pressure.

### SUMMARY

Provided according to the invention is a method for manufacturing a bipolar plate for an electrochemical cell unit for converting electrochemical energy into electrical energy as a fuel cell unit and/or for converting electrical energy into electrochemical energy as an electrolytic cell unit having stacked electrochemical cells, said method comprising the following steps: providing a first plate and a second plate; stacking the first plate and the second plate on top of one another such that inner surfaces of the first and second plates lie on top on each other and an intermediate space is formed between the first and second plates, fluid-tightly sealing the intermediate space with respect to the surroundings using at least one sealing means for preventing the inflow of a fluid from the surroundings into the intermediate space; applying contact forces to the first and/or second plate, so that, as a result of the applied contact forces, the inner surfaces of the first and second plates lie on one another with an additional compressive force in a contact region due to the applied contact forces by applying a negative pressure to the intermediate space relative to an ambient pressure, said negative pressure in the intermediate space causing the contact forces applied to the first and/or second plate to be applied to the first and/or second plate by the ambient pressure; and producing a welded joint between the first and second plate, the intermediate space being sealed using at least one film as the at least one sealing means. The at least one sealing means as the at least one film can be simply applied to the outside of the first and/or second plate, e.g. by means of a robot, and enables reliable sealing of the intermediate space. The welded joint between the first and second plates generally includes a plurality of separate weld seams. The additional compressive force thus acts in addition to the compressive force due to the weight force resulting from the gravitational force of the second plate.

In an additional embodiment, the negative pressure in the intermediate space is at least 100 mbar, 300 mbar, or 500 mbar less than the ambient pressure. The ambient pressure is generally about 1000 mbar so that a pressure difference between the intermediate space and the surroundings of 700 mbar occurs for a negative pressure of 300 mbar in the intermediate space. The ambient pressure of 1000 mbar thus acts on the outer surfaces of the first and second plates and the negative pressure of 300 mbar acts on the inner surfaces of the first and second plates so that, due to this pressure difference, the compressive forces on the outer surfaces are greater than on the inner surfaces, so the first and second plate with the additional compressive force lie on one another as the resulting total force without taking gravity into account.

In a further embodiment, the first plate is first placed on a support plate and then the second plate is placed on the first plate.

In another embodiment, the intermediate space between the first and second plates is sealed with the at least one film with respect to the surroundings after the second plate is placed on the first plate.

In an additional embodiment, the intermediate space opening in an outer edge of the first and second plates lying on top of one another is sealed using the at least one film. Provided on the outer edge is a circumferential gap, in particular a technical zero gap between the first and second plates, and this gap is sealed by the at least one film. The at least one film is preferably arranged completely around the outer edge.

In a further embodiment, the intermediate space opening in fluid openings of the first and second plates lying on top of one another is sealed using the at least one film. Provided on the fluid openings is a circumferential gap, in particular a technical zero gap between the first and second plates, and this gap is sealed by the at least one film.

Preferably, the at least one film is placed on the at least one outer surface of the stacked first and/or second plate.

In a further embodiment, at least 30%, 50%, 70% or 90%, in particular all, of the at least one film is placed on the surface of the at least one outer surface of the stacked first and/or second plate and is covered by the at least one film.

In another embodiment, the at least one film is placed on to the at least one outer surface of the stacked first and/or second plate by unwinding the at least one film from a roll and then placing it on the at least one outer surface of the stacked first and/or second plate.

In particular, the welded joint produced by means of laser welding.

In a further embodiment, the at least one film is placed on a region of the at least one outer surface of the first and/or second plate onto which the laser beam emitted by a laser is directed as a focal spot for producing the welded joint such that the at least one film is penetrated and/or dissolved, in particular melted and/or vaporized, by the laser beam during the production of the welded joint using the laser beam. This facilitates the process-related application of the film to the outer surface of the first and/or second plate, because the at least one film can also be applied to regions of the outer surface of the first and/or second plate in which the welded joint is produced by means of the laser beam.

In another embodiment, the at least one film is removed, in particular completely, from the at least one outer surface of the first and/or second plate stacked on one after the other after the production of the welded joint. After removal of the at least one film, the at least one film has no contact with the bipolar plate.

In an additional embodiment, during the production of the welded joint, in particular continuously, the intermediate space is applied at negative pressure relative to the ambient pressure. Preferably, the negative pressure in the intermediate space is maintained continuously and substantially constantly during the production of the entire welded joint. Preferably, the term “substantially constant” means having a deviation of less than 30%, 20% or 10%.

Provided is a method for manufacturing an electrochemical cell unit according to the invention for converting electrochemical energy into electrical energy as a fuel cell unit and/or for converting electrical energy into electrochemical energy as an electrolytic cell unit with stacked electrochemical cells, comprising the following steps: providing layered components of the electrochemical cells, namely preferably proton exchange membranes, anodes, cathodes, preferably gas diffusion layers and bipolar plates, stacking the layered components to form electrochemical cells and to form a stack of the electrochemical cell unit, the bipolar plates being provided by performing a method described in the present patent application.

Provided is an electrochemical cell unit according to the invention for converting electrochemical energy into electrical energy as a fuel cell unit and/or for converting electrical energy into electrochemical energy as an electrolytic cell unit comprising stacked electrochemical cells and the electrochemical cells each comprise stacked layered components and the components of the electrochemical cells are preferably proton exchange membranes, anodes, cathodes, preferably gas diffusion layers and bipolar plates, whereby the electrochemical cell unit is produced by a method described in the present patent application, and/or the first and/or second plates having no clamping markings. In the prior art, the contact forces are applied substantially selectively to the outer surfaces of the first and second plates using hold-down devices as gripping pliers, so that clamping markings are formed as a result. These clamping markings are, for example, optically visible scorings, grooves, grinding traces or indentations and/or changes in the structure on the surface and/or inside the first and/or second plate that can be detected using material analysis methods, in particular a change in the lattice structure of the atoms and/or molecules.

In a further embodiment, during the reduction of the pressure in the intermediate space to achieve the negative pressure relative to an ambient pressure in the intermediate space, the at least one film is moved from the outer surface in the direction of the intermediate space due to the negative pressure on the outer surface of the first and/or second plate. The negative pressure causes the at least one film to be sucked into the intermediate space.

In a further embodiment, the at least one film is made of plastic, preferably polyolefins, e.g. polyethylene (PE) and/or polypropylene (PP). Preferably, the at least one film is made of polyvinyl chloride (PVC) and/or polystyrene (PS), and/or polyester and/or polycarbonate (PC).

In another embodiment, the at least one film is made of cellophane.

In another embodiment, the at least one film is made of bio-based plastics, preferably polylactic acid (PLA) and/or cellulose acetate and/or starch blends.

Preferably, the at least one film has a thickness and/or wall thickness of between 2 μm to 2 mm, in particular between 2 μm and 1 mm.

In a further embodiment, the at least one film is formed as an adhesion film. The at least one film is thus adhered to the outer surface of the first and/or second plate without adhesive, preferably using Van-der Waals bonds.

In an additional embodiment, the at least one film is formed as an adhesive film. The at least one film as an adhesive film has a coating with an adhesive on one side and this side with the coating with the adhesive is placed on the at least one outer surface of the first and/or second plate, so that the at least one film adheres to the at least one outer surface of the first and/or second plate by means of an adhesive bond.

In an additional embodiment, the at least one film is placed on the at least one outer surface of the first and/or second plate by first unwinding the at least one film from a roll and then placing it on the at least one outer surface of the first and/or second plate.

The at least one film is advantageously placed on the at least one outer surface of the first and/or second plate by means of a robot.

In another embodiment, the at least one film is nor reused after the production of the welded joint. The at least one film is thus a disposable product. Due to the low production costs of the at least one film, the use of the at least one film as a disposable product only requires negligible costs.

In an additional embodiment, during and/or after the application of the at least one film to the at least one outer surface of the first and/or second plate, the target position of the at least one film on the outer surface of the first and/or second plate is checked and/or detected by means of a camera and image processing software, and preferably if the actual position deviates from the target position of the at least one film on the at least one outer surface of the first and/or second plate, an error message is issued and/or the at least one film is additionally applied independently or automatically such that the actual position corresponds to the target position of the at least one film on the at least one outer surface of the first and/or second plate.

In an additional embodiment, the at least one film is mechanically and/or thermally and/or pneumatically removed from the outer surface of the first and second plate stacked on one another after the welded joint is produced. The mechanical removal is performed by means of, for example, a rotating brush and/or a movable wiper. The thermal removal is performed using, for example, a thermal radiator and/or a gas flame. Pneumatic removal is performed by means of compressed air, for example, from a nozzle. Preferably, removal of the at least one film is performed using the robot. For this purpose, a process unit for removing the film, in particular the rotating brush, the thermal radiator and/or the nozzle for compressed air, is attached to one arm of the robot.

In an additional embodiment, the complete removal of the film from the at least one outer surface of the first and/or second plate is checked and/or detected by means of a camera and image processing software and preferably, if there are still residues of the film on regions of the at least one outer surface of the first and/or second plate, these are localized accordingly by the camera and image processing software and are then automatically removed, in particular mechanically and/or thermally and/or pneumatically, for example by moving a rotating brush to the regions with the remaining film by the arm of the robot. Preferably, the camera is attached to an arm of the robot so that this monitoring of the complete removal of the film is also performed automatically by the robot.

In an additional embodiment, the support plate comprises an elastic sealing layer at the top such that the first plate is placed on the elastic sealing layer of the support plate. The modulus of elasticity of the elastic sealing layer is advantageously between 0.1 and 10 GPa. Preferably, the sealing layer is connected to the remaining support plate in a material-locking fashion, in particular by injection molding and/or 3D printing. Preferably, the remaining support plate is made of metal, in particular steel, and/or with a modulus of elasticity greater than 100 GPa.

In a further embodiment, a process intermediate space is formed between the first plate and the support plate, and the process intermediate space is applied at negative pressure relative to an ambient pressure such that the first plate rests on the support plate as a result of the negative pressure at a process additional compressive force, particularly without taking gravity into account. Preferably, the process intermediate space is formed from a plurality of process intermediate subspaces, which are preferably fluidly connected to each other. For example, at a negative pressure on an outer surface as the underside of a first lower plate and an ambient pressure on an outer surface as the upper side of a second top plate, contact forces for the additional compressive force on the outer surface as the underside of the first bottom plate are also mechanically applied by means of the contact of the outer surface as the underside of the first lower plate at the additional process compressive force on the support plate.

In a further embodiment, the intermediate space between the first and second plates comprises channels for coolant. Preferably, the intermediate space between the first and second plates comprises technical zero gaps at the contact region.

In another embodiment, during the provision of the negative pressure in the intermediate space, the intermediate space is filled with an inert gas, in particular nitrogen or a noble gas. The negative pressure in the intermediate space is produced using a vacuum pump to draw the inert gas from a reservoir with inert gas through the intermediate space, then producing the negative pressure in the intermediate space, and optionally then conducting the inert gas through the intermediate space while maintaining the negative pressure in the intermediate space.

In a supplementary embodiment, during the impact of the laser beam on a focal spot on the outer surface of the first plate, an inert gas is conducted to the focal spot, in particular by means of a movable nozzle.

In a further embodiment, the intermediate space is applied at a negative pressure relative to an ambient pressure such that the contact forces applied to the first and/or second plates are applied substantially to the first and/or second plates by the ambient pressure. Substantially means preferably that at least 70%, 80% or 90% of the contact forces result from the ambient pressure. Without negative pressure, the second plate only rests on the first plate due to the weight force acting on the second plate at a compressive force due to the gravity.

In an additional embodiment, after stacking the first and second plates, a portion of the inner surface of the first plate rests on a portion of the inner surface of the second plate at the contact region and, outside the contact region, at least one channel, preferably multiple channels, for coolant is/are formed between the inner surfaces of the first and second plates due to the distance between the inner surfaces of the first and second plates in a direction perpendicular to an imaginary plane subtended by the bipolar plate. Preferably, the imaginary planes subtended from the first and second plates are substantially aligned parallel to one another after stacking, in particular with a deviation of less than 30°, 20°, or 10°.

Preferably, the at least one weld seam produced by laser beam welding forms a seal for sealing the at least one channel for coolants outwardly between the first and second plate.

In a further embodiment, at least 90% of the bipolar plates, in particular all bipolar plates, are provided to the fuel cell unit by performing a method described in the present patent application.

In another embodiment, the first and second plates are provided at least partly, in particular completely, made of metal, in particular stainless steel and/or aluminum, and/or plastic and/or composite material.

In another embodiment, the first and second plates are provided at least partly, in particular completely, as wave-shaped and/or disc-shaped and/or in a layered fashion.

In a further embodiment, the bipolar plate is formed from two or three plates, and the two or three plates are connected to each other via the welded joint using the method described in the present patent application.

In another embodiment, the at least one welded connection of the bipolar plate is produced, in particular exclusively, at the contact region.

In a further embodiment, the thickness of the first and second plates is between 5 μm and 1000 μm, in particular between 20 μm and 300 μm.

Preferably, the membrane electrode arrangements are each formed by a proton exchange membrane, one anode and one cathode, in particular as a CCM (catalyst coated membrane) with catalyst material in the anodes and cathodes.

In another embodiment, the electrochemical cell unit comprises at least 50, 100, 200 or 400 stacked electrochemical cells.

The invention further comprises a computer program having a program code means stored on a computer-readable data carrier for performing a method described in the present patent application when the computer program is executed on a computer or a corresponding computing unit.

The invention further relates to a computer program product comprising program code means stored on a computer-readable data carrier for performing a method described in the present patent application when the computer program is executed on a computer or a corresponding computing unit.

In another embodiment, the electrochemical cell unit comprises a housing and/or a connector plate. The stack is enclosed by the housing and/or the connector plate.

Provided is a fuel cell system according to the invention, in particular for a motor vehicle, comprising a fuel cell unit as a fuel cell stack comprising fuel cells, a compressed gas reservoir for storing gaseous fuel, a gas conveying device for conveying a gaseous oxidizing agent to the cathodes of the fuel cells, whereby the fuel cell unit is designed as a fuel cell unit and/or electrolytic cell unit described in the present patent application.

Electrolysis system and/or fuel cell system according to the invention, comprising an electrolytic cell unit as an electrolysis cell stack comprising electrolysis cells, preferably a compressed gas reservoir for storing gaseous fuel, preferably a gas conveying device for conveying a gaseous oxidizing agent to the cathodes of the fuel cells, a storage reservoir for liquid electrolyte, a pump for conveying the liquid electrolyte, wherein the electrolytic cell unit is designed as an electrolytic cell unit and/or fuel cell unit described in the present patent application.

In a further embodiment, the fuel cell unit described in the present patent application also forms an electrolytic cell unit acting as a reversible fuel cell unit, and preferably vice versa.

In another embodiment, the electrochemical the cell unit, in particular combustible fuel cell unit and/or the electrolytic cell unit, comprises at least one connection device, in particular multiple connection devices, as well as clamping elements.

Advantageous components for electrochemical cells, in particular fuel cells and/or electrolytic cells, are preferably insulating layers, in particular proton exchange membranes, anodes, cathodes, preferably gas diffusion layer and bipolar plates, in particular separator plates.

In a further embodiment, the connecting device is designed as a bolt and/or is rod-shaped and/or is formed as a tensioning belt.

The tensioning elements are advantageously designed as clamping plates.

In another embodiment, the gas conveying device is designed as a blower, and/or a compressor, and/or a pressure reservoir having an oxidizing agent.

In particular, the electrochemical cell unit, in particular fuel cell unit and/or electrolytic cell unit, comprises at least 3, 4, 5 or 6 connection devices.

In an additional embodiment, the tensioning elements are plate-shaped and/or disc-shaped and/or planar and/or designed as a grid.

Preferably, the fuel is hydrogen, hydrogen-rich gas, reformate gas, or natural gas.

The fuel cells and/or electrolysis cells are designed to be essentially flat and/or disk-shaped.

In another embodiment, the oxidizing agent is air comprising oxygen or pure oxygen.

Preferably, the fuel cell unit is a PEM fuel cell unit comprising PEM fuel cells or a SOFC fuel cell unit comprising SOFC fuel cells or an alkaline fuel cell (AFC).

### BRIEF DESCRIPTION OF THE DRAWINGS

In the following, exemplary embodiments of the invention are described in more detail with reference to the accompanying drawings. Shown are:

FIG. 1 a highly simplified exploded view of an electrochemical cell system as a fuel cell system and electrolysis cell system comprising components of an electrochemical cell as a fuel cell and electrolysis cell,

FIG. 2 a perspective view of part of a fuel cell and electrolysis cell,

FIG. 3 a longitudinal section through electrochemical cells as fuel cells and electrolytic cells,

FIG. 4 a perspective view of an electrochemical cell unit as a fuel cell unit and electrolytic cell unit as a fuel cell stack and electrolytic cell stack,

FIG. 5 a side view of the electrochemical cell unit as a fuel cell unit and electrolytic cell unit as a fuel cell stack and electrolytic cell stack,

FIG. 6 a perspective view of a bipolar plate,

FIG. 7 an enlarged longitudinal section through a fuel cell and electrolytic cell in the region of a weld seam,

FIG. 8 a longitudinal section through a bipolar plate comprising two plates which are joined to one another using a weld seam in the form of a through-weld, and a welded-in joint is also formed,

FIG. 9 a longitudinal section through a bipolar plate comprising two plates which are joined to one another using a weld seam in the form of a weld-in during the welding process using a laser beam,

FIG. 10 a longitudinal section through the two plates when laid upon a support plate during the welding operation,

FIG. 11 a longitudinal section A-A according to FIG. 6 through the two plates after the application of a film as sealing means in a first exemplary embodiment without a representation of the support plate,

FIG. 12 a longitudinal section A-A according to FIG. 6 through the two plates after application of the film as sealing means in a second exemplary embodiment without a representation of the support plate,

FIG. 13 a longitudinal section A-A according to FIG. 6 through the two plates after application of the film as sealing means in a third exemplary embodiment without a representation of the support plate, and

FIG. 14 a highly simplified representation of a robot with a roll of the film.

### DETAILED DESCRIPTION

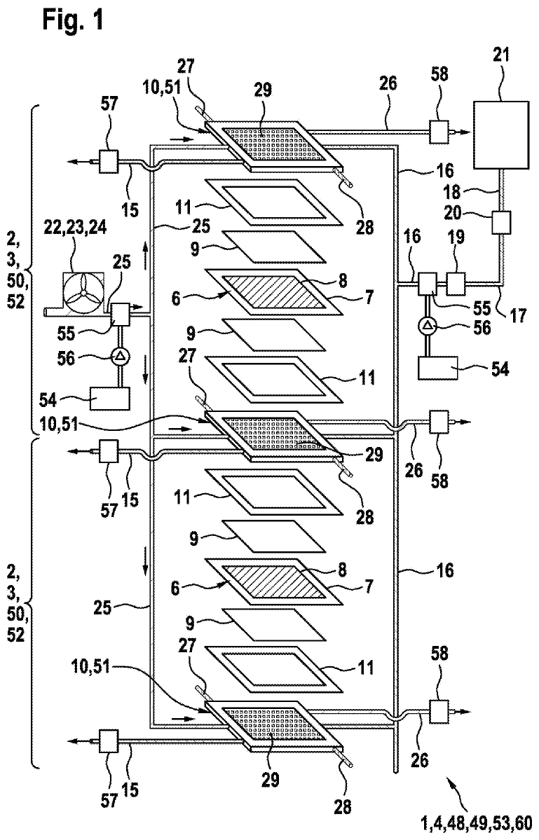

In FIGS. 1 to 3, the basic construction of a fuel cell 2 is shown as a PEM fuel cell 3 (polymer electrolyte fuel cell 3). The principle of fuel cells 2 is that electrical energy or electrical current is generated by means of an electrochemical reaction. Hydrogen H₂ is conducted to an anode 7 as a gaseous fuel, and the anode 7 forms the negative pole. A gaseous oxidant, i.e., air with oxygen, is conducted to a cathode 8, i.e., the oxygen in the air provides the necessary gaseous oxidant. A reduction (electron uptake) takes place on the cathode 8. The oxidation as electron output is performed at the anode 7.

The redox equations of the electrochemical processes are as follows:

O₂+4H⁺+4e⁻--»2H₂O Cathode:

2H₂--»4H⁺+4e⁻ Anode:

2H₂+O₂--»2H₂O Summed reaction equation of cathode and anode:

The difference in the normal potentials of the electrode pairs under standard conditions as reversible fuel cell voltage or neutral voltage of the unloaded fuel cell 2 is 1.23 V. This theoretical voltage of 1.23 V is not achieved in practice. At rest and at small currents, voltages above 1.0 V can be achieved and, in operation at larger currents, voltages between 0.5 V and 1.0 V are achieved. The series connection of multiple fuel cells 2, in particular a fuel cell unit 1 as a fuel cell stack 1 of multiple stacked fuel cells 2, has a higher voltage, which corresponds to the number of fuel cells 2 multiplied by the individual voltage of each fuel cell 2.

The fuel cell 2 also comprises a proton exchange membrane 5 (PEM), which is arranged between the anode 7 and the cathode 8. The anode 7 and cathode 8 are designed in a layer or disc shape. The PEM 5 functions as an electrolyte, catalyst carrier, and separating device for the reaction gases. The PEM 5 also functions as an electrical insulator and prevents an electrical short circuit between the anode 7 and cathode 8. In general, 12 μm to 150 μm thick, proton-conductive films made of perfluorinated and sulfonated polymers are used. The PEM 5 conducts the protons H⁺ and substantially blocks ions other than protons H⁺ so that charge transport can occur due to the permeability of PEM 5 for the protons H⁺. The PEM 5 is substantially impermeable to the reaction gases oxygen O₂ and hydrogen H₂, i.e. it blocks the flow of oxygen O₂ and hydrogen H₂ between a gas chamber 31 at the anode 7 with hydrogen fuel H₂ and the gas chamber 32 at the cathode 8 with air or oxygen O₂ as oxidizing agents. The proton conductivity of the PEM 5 increases with increasing temperature and increasing water content.

On the two sides of the PEM 5, each facing the gas chambers 31, 32, the electrodes 7, 8 are located as the anode 7 and cathode 8. A unit consisting of the PEM 5 and the electrodes 7, 8 is referred to as a membrane electrode arrangement 6 (MEA). The electrodes 7, 8 are pressed together using the PEM 5. The electrodes 7, 8 are platinum-containing carbon particles bonded to PTFE (polytetrafluorethylene), FEP (fluorinated ethylene-propylene copolymer), PFA (perfluoroalkoxy), PVDF (polyvinylidene fluoride), and/or PVA (polyvinyl alcohol) and hot-pressed in microporous carbon fiber, glass fiber, or plastic mats. A catalyst layer 30 is normally applied to each of the electrodes 7, 8 on the side facing the gas chambers 31, 32 (not shown). The catalyst layer 30 at the gas chamber 31 with fuel at the anode 7 comprises nanodispersed platinum-ruthenium on graphitized carbon black particles bonded to a binder. The catalyst layer 30 on the gas chamber 32 having oxidizer on the cathode 8 similarly comprises nanodispersed platinum. For example, binders include Nafion®, a PTFE emulsion, or polyvinyl alcohol.

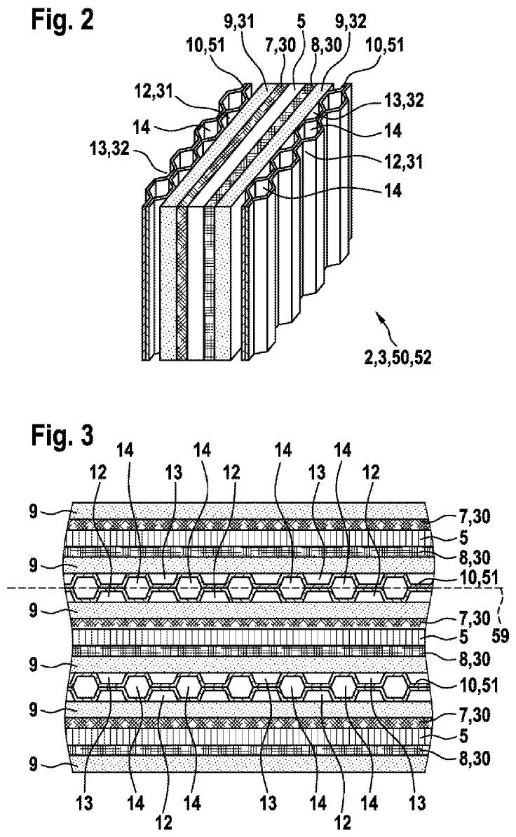

In contrast, the electrodes 7, 8 are composed of an ionomer, e.g. Nafion®, platinum-containing carbon particles and additives. These electrodes 7, 8 comprising the ionomer are electrically conductive due to the carbon particles and also conduct the protons H+ and also act as a catalyst layer 30 (FIGS. 2 and 3) due to the platinum-containing carbon particles. Membrane electrode arrangements 6 having these electrodes 7, 8 and comprising the ionomer form membrane electrode arrangements 6 as CCM (catalyst coated membrane).

A gas diffusion layer 9 (GDL) is located on the anode 7 and cathode 8. The gas diffusion layer 9 at the anode 7 evenly distributes the fuel from channels 12 for fuel to the catalyst layer 30 at the anode 7. The gas diffusion layer 9 on the cathode 8 evenly distributes the oxidizer from channels 13 for oxidizer onto the catalyst layer 30 at the cathode 8. The GDL 9 also draws reaction water counter to the direction of flow of the reaction gases, i.e. in a direction from the catalyst layer 30 or electrodes 7, 8 to the channels 12, 13. Furthermore, the GDL 9 keeps the PEM 5 moist and conducts the power. The GDL 9, for example, is composed of a hydrophobized carbon paper as a carrier and substrate layer and a bonded carbon powder layer as a microporous layer.

A bipolar plate 10 lies atop the GDL 9. The electrically conductive bipolar plate 10 serves as a current collector, for draining water and for conducting the reaction gases as process fluids through the channel structures 29 and/or flow fields 29 and for dissipating the waste heat, which occurs in particular during the exothermic electrochemical reaction at the cathode 8. To dissipate waste heat, channels 14 are incorporated into the bipolar plate 10 as a channel structure 29 for conducting a liquid or gaseous coolant through as a process fluid. The channel structure 29 on the gas chamber 31 for fuel is formed by channels 12. The channel structure 29 on the gas chamber 32 for oxidizing agents is formed by channels 13. For example, metal, conductive plastics, and composites and/or graphite are used as the material for the bipolar plates 10.

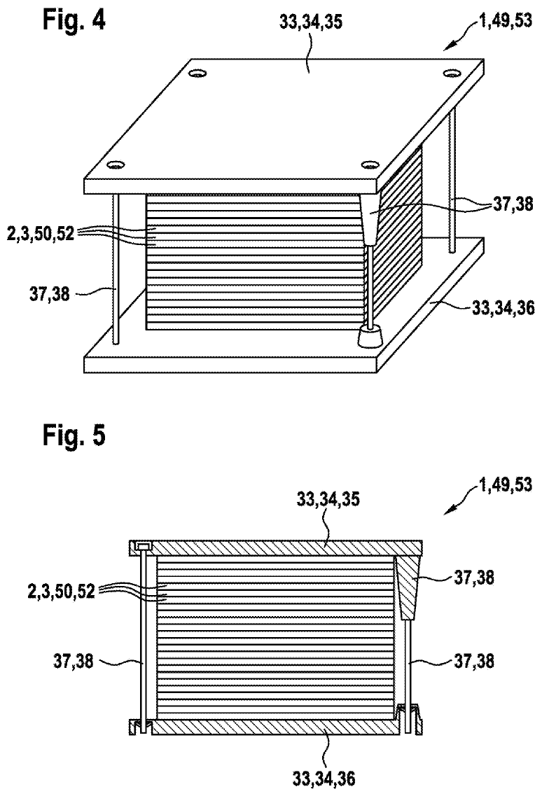

In a fuel cell unit 1 and/or a fuel cell stack 1 and/or a fuel cell stack 1, multiple fuel cells 2 are arranged so to as to be stacked in alignment (FIGS. 4 and 5). FIG. 1 shows an exploded view of two fuel cells 2 arranged in an aligned stack. Sealing gaskets 11 seal the gas chambers 31, 32 or channels 12, 13 in a fluid-tight manner. In a compressed gas reservoir 21 (FIG. 1), hydrogen H₂ is stored as a fuel at a pressure of, e.g., 350 bar to 700 bar. From the compressed gas reservoir 21, the fuel is conducted through a high pressure line 18 to a pressure reducer 20 in order to reduce the pressure of the fuel in a medium pressure line 17 of about 10 bar to 20 bar. From the medium pressure line 17, the fuel is conducted towards an injector 19. At the injector 19, the pressure of the fuel is reduced to an injection pressure of between 1 bar and 3 bar. From the injector 19, the fuel is supplied to a fuel supply line 16 (FIG. 1) and from the supply line 16 to the fuel channels 12 forming the channel structure 29 for fuel. As a result, the fuel flows through the gas chamber 31 for the fuel. The gas chamber 31 for the fuel is formed by the channels 12 and the GDL 9 at the anode 7. After flowing through the channels 12, the fuel not consumed in the redox reaction at the anode 7 (and optionally water from a controlled humidification means of the anode 7) is conducted out of the fuel cells 2 via a discharge line 15.

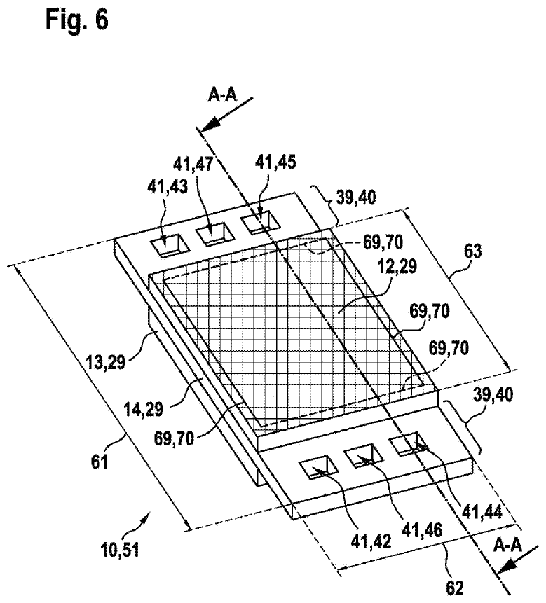

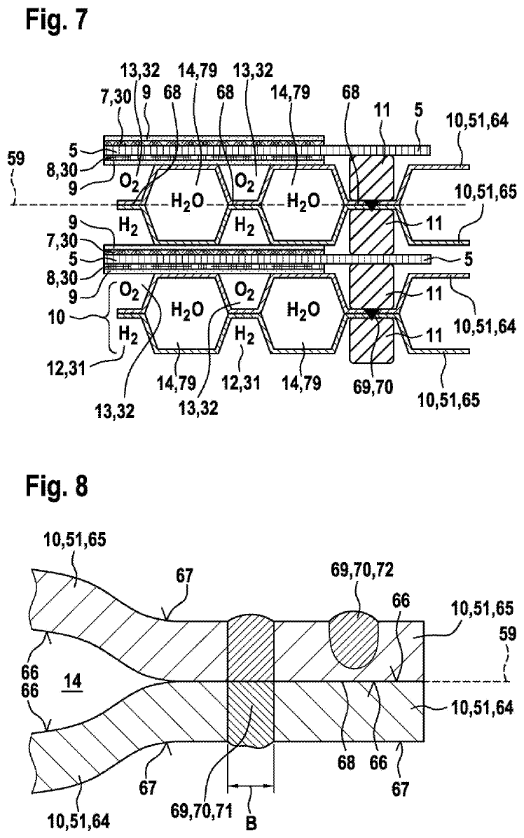

A gas conveying device 22, designed as, e.g., a blower 23 or a compressor 24, conveys air from the surroundings as an oxidizing agent into an oxidizing agent supply line 25. From the supply line 25, the air is supplied to the oxidizing agent channels 13, which form a channel structure 29 on the bipolar plates 10 for oxidizing agents such that the oxidizing agent flows through the gas chamber 32 for the oxidizing agent. The gas chamber 32 for the oxidizing agent is formed by the channels 13 and the GDL 9 on the cathode 8. After flowing through the channels 13 or the gas chamber 32 for the oxidizing agent 32, the oxidizing agent not consumed on the cathode 8 and the reaction water resulting on the cathode 8 due to the electrochemical redox reaction are conducted out of the fuel cells 2 through a discharge line 26. A supply line 27 is used to supply coolant into the channels 14 for coolant, and a discharge line 28 is used to discharge coolant conducted through the channels 14. The supply and discharge lines 15, 16, 25, 26, 27, 28 are shown as separate lines in FIG. 1 for reasons of simplification. Formed the end region in the vicinity of the channels 12, 13, 14 are fluid openings 41 in the stack of the fuel cell unit 1 on sealing plates 39 as an extension at the end region 40 of the bipolar plates 10 (FIG. 6) and membrane electrode arrangements 6 (not shown) lying one atop the other. The fuel cells 2 and the components of the fuel cells 2 are disk-shaped and span imaginary planes 59 that are essentially parallel to one another. The fluid openings 41 and seals (not shown) that are flush in a direction perpendicular to the imaginary planes 59 between the fluid openings 41 therefore form a supply channel 42 for an oxidizing agent, a discharge channel 43 for an oxidizing agent, a supply channel 44 for fuel, a discharge channel 45 for fuel, a supply channel 46 for coolant, and a discharge channel 47 for coolant. The supply and discharge lines 15, 16, 25, 26, 27, 28 outside the stack of the fuel cell unit 1 are designed as process fluid lines. The supply and discharge lines 15, 16, 25, 26, 27, 28 outside the stack of the fuel cell unit 1 open into the supply and discharge channels 42, 43, 44, 45, 46, 47 inside the stack of the fuel cell unit 1. The fuel cell stack 1, together with the compressed gas reservoir 21 and the gas conveying device 22, form a fuel cell system 4.

In the fuel cell unit 1, the fuel cells 2 are arranged between two clamping elements 33 as clamping plates 34. A first clamping plate 35 rests on the first fuel cell 2 and a second clamping plate 36 rests on the last fuel cell 2. The fuel cell unit 1 comprises approximately 200 to 400 fuel cells 2, not all of which are shown in FIGS. 4 and 5 for graphic reasons. The clamping elements 33 apply a compressive force to the fuel cells 2, i.e., the first clamping plate 35 rests with a compressive force on the first fuel cell 2, and the second clamping plate 36 rests with a compressive force on the last fuel cell 2. The fuel cell stack 2 is thus braced to ensure tightness for the fuel, the oxidizing agent and the coolant, in particular due to the elastic sealing gaskets 11, and also to keep the electrical contact resistance within the fuel cell stack 1 as low as possible. To clamp the fuel cells 2 using the clamping elements 33, four connection devices 37 are designed on the fuel cell unit 1 as bolts 38, which are tensioned. The four bolts 38 are connected to the clamping plates 34.

FIG. 6 shows the bipolar plate 10 of the fuel cell 2. The bipolar plate 10 comprises the channels 12, 13 and 14 as three separate channel structures 29. The channels 12, 13 and 14 are not shown separately in FIG. 6, but merely simplified as a layer of a channel structure 29. The fluid openings 41 on the sealing plates 39 of the bipolar plates 10 and membrane electrode arrangements 6 (not shown) are stacked in alignment within the fuel cell unit 1, so that supply and discharge channels 42, 43, 44, 45, 46, 47 are formed. Sealing gaskets (not shown) are in this case arranged between the sealing plates 39 for the fluid-tight sealing of the supply and discharge channels 42, 43, 44, 45, 46, 47 formed by the fluid openings 41. The bipolar plate 10 has a length 61 and a width 62. The channel 14 or channels 14 in the form of a channel structure 29 have a length 63, and the width of the channel structure 29 substantially corresponds, in particular with a deviation of less than 20% or 10%, to the width 62 of the bipolar plate 10.

Since the bipolar plate 10 also separates the gas chamber 31 for fuel from the gas chamber 32 for oxidizing agent in a fluid-tight manner and also seals the channel 14 for coolant in a fluid-tight manner, the term separator plate 51 can also be selected for the bipolar plate 10 for the fluid-tight decomposition or separation of process fluids. In this context, the term “bipolar plate” 10 also includes the term “separator plate” 51, and vice versa. The channels 12 for the fuel, the channels 13 for the oxidizing agent, and the channels 14 for the coolant of the fuel cell 2 are also formed on the electrochemical cell 52, but with different functions.

In another exemplary embodiment (not shown), the fuel cell unit 1 is designed as an alkaline fuel cell unit 1. Potassium hydroxide solution is used as a mobile electrolyte. The fuel cells 2 are arranged in a stack. A monopolar cell structure or a bipolar cell structure can be formed thereby. The potassium hydroxide solution circulates between an anode and cathode and removes reaction water, heat and impurities (carbonates, dissolved gases). The fuel cell unit 1 can also be operated as a reversible fuel cell unit 1, i.e. as an electrolytic cell unit 49.

The fuel cell unit 1 can also be used and operated as an electrolytic cell unit 49, i.e. it forms a reversible fuel cell unit 1. In the following, some features are described which enable the fuel cell unit 1 to be operated as an electrolytic cell unit 49. A liquid electrolyte, namely highly diluted sulfuric acid at a concentration of approximately c (H₂SO₄)=1 mol/L, is used for electrolysis. A sufficient concentration of oxonium ions H₃O⁺ in the liquid electrolyte is necessary for electrolysis.

The following redox reactions take place during electrolysis:

4HO₃+4e⁻--»2H₂+4H₂O Cathode:

6H₂O--»O₂+4H₃O⁺+e⁻ Anode:

2H₂O--»2H₂+O₂ Summed reaction equation of cathode and anode:

The polarity of the electrodes 7, 8 is reversed using electrolysis during operation as an electrolytic cell unit 49 (not shown) as during operation as a fuel cell unit 1, so that hydrogen H₂ is formed as a second substance at the cathodes in the channels 12 for fuel, through which the liquid electrolyte is conducted, and the hydrogen H₂ is absorbed by the liquid electrolyte and transported in solution. Similarly, the liquid electrolyte is conducted through the channels 13 for oxidizing agents, and oxygen O₂ is formed as the first substance at the anodes in or at channels 13 for oxidizing agents. The fuel cells 2 of the fuel cell unit 1 function as electrolysis cells 50 during operation as electrolytic cell unit 49. The fuel cells 2 and electrolysis cells 50 thus form electrochemical cells 52. The oxygen O₂ formed is absorbed by the liquid electrolyte and transported in solution. The liquid electrolyte is stored in a storage reservoir 54. For reasons of simplification, FIG. 1 shows two storage reservoirs 54 of the fuel cell system 4, which also functions as an electrolysis cell system 48. The three-way valve 55 on the supply line 16 for fuel is switched over during operation as an electrolytic cell unit 49 so that, instead of fuel from the compressed gas reservoir 21, the liquid electrolyte is conducted into the supply line 16 for fuel using a pump 56 from the storage reservoir 54. A three-way valve 55 on the supply line 25 for oxidizing agent is switched over during operation as electrolytic cell unit 49 so that, instead of oxidizing agent as air from the gas conveying device 22, the liquid electrolyte is conducted into the supply line 25 for oxidizing agent using the pump 56 from the storage reservoir 54. The fuel cell unit 1, which also functions as an electrolytic cell unit 49, features optional modifications to the electrodes 7, 8 and the gas diffusion layer 9 compared to a fuel cell unit 1 that can only be operated as a fuel cell unit 1. For example, the gas diffusion layer 9 is not absorbent, so that the liquid electrolyte easily runs off completely, or the gas diffusion layer 9 is not formed, or the gas diffusion layer 9 is a structure on the bipolar plate 10. The electrolytic cell unit 49 comprising the storage reservoir 54, the pump 56, the separators 57, 58, and preferably the three-way valve 55 forms an electrochemical cell system 60.

A separator 57 for hydrogen is arranged on the discharge line 15 for fuel. The separator 57 separates the hydrogen from the electrolyte comprising hydrogen, and the separated hydrogen is conducted into the compressed gas reservoir 21 by means of a compressor (not shown). The electrolyte conducted out of the separator 57 for hydrogen is then fed back into the storage reservoir 54 for the electrolyte via a line. A separator 58 for oxygen is arranged on the discharge line 26 for fuel. The separator 58 separates the oxygen from the electrolyte comprising oxygen, and the separated oxygen is fed into a compressed gas reservoir for oxygen (not shown) using a compressor (not shown). The oxygen in the compressed gas reservoir for oxygen (not shown) can optionally be used for operating the fuel cell unit 1 by conducting the oxygen into the supply line 25 for oxidizing agent using a line (not shown) during operation as a fuel cell unit 1. The electrolyte conducted out of the separator 58 for oxygen is then fed back into the storage reservoir 54 for the electrolyte via a line. The channels 12, 13 and the discharge and supply lines 15, 16, 25, 26 are designed such that, after use as an electrolytic cell unit 49 and the pump 56 has been switched off, the liquid electrolyte runs back completely into the storage reservoir 54 due to gravity. Optionally, after use as an electrolytic cell unit 49 and before use as a fuel cell unit 1, an inert gas is conducted through the channels 12, 13 and the discharge and supply lines 15, 16, 25, 26 to completely remove the liquid electrolyte before the gaseous fuel and oxidizing agent are conducted through. The fuel cells 2 and the electrolysis cells 2 thus form electrochemical cells 52. The fuel cell unit 1 and the electrolytic cell unit 49 thus form an electrochemical cell unit 53. The channels 12 for fuel and the channels for oxidizing agent thus form channels 12, 13 for conducting the liquid electrolyte through during operation as an electrolytic cell unit 49, and this applies in a similar manner to the supply and discharge lines 15, 16, 25, 26. For process-related reasons, an electrolytic cell unit 49 does not normally require channels 14 for the conduction of coolant. In an electrochemical cell unit 49, the channels 12 for fuel also form channels 12 for conducting fuel and/or electrolytes through, and the channels 13 for oxidizing agents also form channels 13 for guiding fuel and/or electrolytes.

The bipolar plates 10 are produced from the first plate 64 and the second plate 65 as monopolar plates 64, 65 using laser steel welding. For this purpose, for each bipolar plate 10, a correspondingly wave-shaped first and second plate 64, 65 is placed on top of one another and stacked so that the inner surfaces 66 of the first and second plates 64, 65 lie on top of one another at strip-shaped contact regions 68 as a butt joint. The imaginary planes 59 subtended by the disc-shaped first and second plates 64, 65 are subsequently aligned substantially parallel to each other. The first and second stainless steel plates 64, 65 each comprise an outer surface 67 opposite to the inner surfaces 66. After arranging the two plates 64, 65 as output plates 64, 65 for the manufacture of the bipolar plates 10, strip-shaped coolant channels 14 for coolant are formed outside the strip-shaped contact regions 68 between the inner surfaces 66 of the first and second plates 64, 65, which form an intermediate space 79. The geometry of the first and second plates 64, 65 provided with a large number of waves causes a large number of channels 14 to be formed between the contact regions 68.

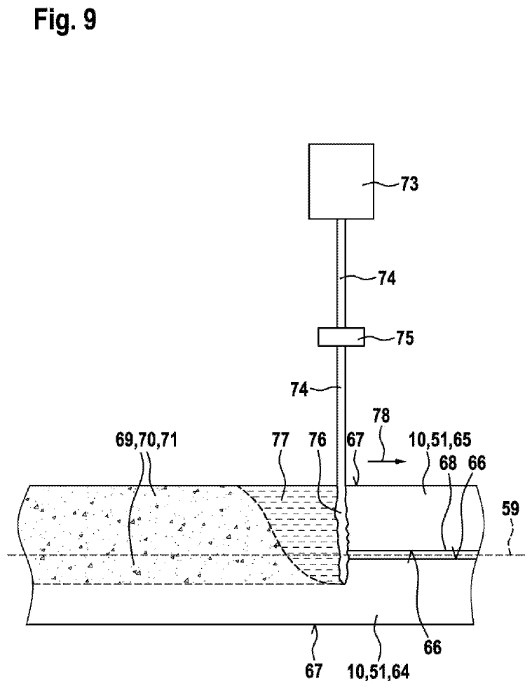

The first and second plates 64, 65 as monopolar plates 64, 65 are joined together in a material-locking manner by laser beam welding to form the bipolar plate 10 such that a welded joint 69 is produced as a large number of weld seams 70 between the first and second plates 64, 65. A laser system includes a laser 73 that emits a laser beam 74 (FIG. 9). The laser 73 emits a laser beam 74 as a bundled electromagnetic wave. The laser beam 74 is emitted onto the outer surface 67 of the second plate 65 by an optical system 75 such that the laser beam 74 impinges on the outer surface 67 of the second plate 65 at a focal spot having a diameter of about 70 μm. A motion unit (not shown) moves either the laser beam 74 over the outer surface 67 of the second plate 65 and/or the first and second plates 64, 65 below the laser beam 74 such that a relative feed direction 78 of the laser beam 74 to the first and second plates 64, 65 is achieved. The laser beam 74 is absorbed by the outer surface 67 of the second plate 65 such that during the welding process the temperature of the stainless steel of the first and second plate 64, 65 rises above the melting temperature, thereby forming a liquid melt 77 during the welding process, which subsequently cools down again and solidifies to form the welded joint 69 as the weld seam 70. Furthermore, a keyhole 76 optionally forms as a vapor capillary in the liquid melt 76 in the beam direction of the laser beam 74, which is formed as a tubular cavity of metal vapor and/or partially ionized metal vapor, respectively, in each case below the laser beam 74, which is moved relative to the first and second plates 64, 65 in the feed direction 78. Depending on the depth of the optional keyhole 76 and the liquid melt 77, a through-weld 71 or a weld-in 72 (FIG. 8) of the welded joint 70 is formed. The width B (FIG. 8) of the weld seam 70 substantially corresponds to the diameter of the laser beam 74 or focal spot.

The weld seam 70 is made completely continuous (shown as a continuous straight line in FIG. 6) at edge regions near the longitudinal sides of the channel structure 29 from the channels 14 for coolant and is produced with one or more interruptions (shown as a dashed straight line in FIG. 6) at the edge regions near the wide sides of the channel structure 29 from the channels 14 for coolant facing the supply channel, so that the coolant can be conducted into the channel structure 29 from the supply channel 46 for coolant and can be conducted out of the channel structure 29 into the discharge channel 47 for coolant. For this purpose, structures (not shown) in the bipolar plate 10 for directing the coolant from the supply channel 46 for coolant into the channel structure 29 and from the channel structure 29 into the discharge channel 47 for coolant are formed. The fully continuous weld seam 70 is additionally (not shown entirely) preferably circumferentially designed so that the intermediate space 79 is sealed from the surroundings. This weld seam 70 (not shown entirely) thus also acts as a seal for sealing the channels 14 for coolant to the surroundings outside the channels 14. Optionally, further weld seams 70 formed in sections may be produced at the contact regions 68 that do not have a sealing function for the coolant in the surroundings or to the outside and only serve to provide a material-locking connection of the two plates 64, 65 and optionally also function as a seal between two channels 14 for coolant.

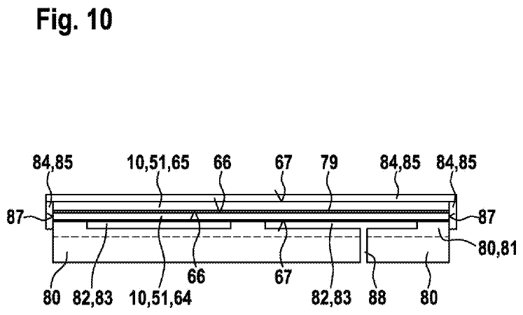

To manufacture the bipolar plate 10, the first plate 64 and the second plate 65 are first made of stainless steel. The first and second plates 64, 65 have a thickness of approximately 70 μm. A horizontal and planar support plate 80 made of steel (FIG. 10) has an elastic sealing layer 81 made of rubber at the top side. A plurality of recesses are formed in this elastic sealing layer 81, which form process intermediate subspaces 83 after the first plate 64 has been placed on the elastic sealing layer 81. After the first plate 64 has been placed on the elastic sealing layer 81 of the support plate 80, a vacuum is generated in the process intermediate subspaces 83 by a vacuum pump (not shown). A suction channel 88 is formed in the support plate 80 for this purpose (FIG. 10). The suction channel 88 is fluidly connected to all of the process intermediate subspaces 83 and the process intermediate subspaces 83 constitute a total of one process intermediate space 82. The negative pressure in the process intermediate space 82 on the one hand between the outer surface 67 of the first plate 64 and the top of the support plate 80 is low and is in the ranges of about 800 mbar, i.e. the difference between the negative pressure vacuum and the ambient pressure is about 200 mbar. Due to this negative pressure in the process intermediate space 82, the first plate 64 with a process additional compressive force rests on the top side of the support plate 80. The outer surface 67 of the first plate 64 therefore adjoins the support plate 80 with a compressive force formed from the sum of the process additional compressive force and the gravitational force of the first plate 64. As a result, a reliable interlocking and/or frictional connection between the lower outer surface 67 of the first plate 64 and the top of the support plate 80 such that the first plate 64 is thereby positioned precisely relative to the support plate 80 without displacement and thus the weld seams 80 can be accurately produced at the correct positions.

The second plate 65 is then placed in the exact position on the first plate 64. A sealing means 84 is then arranged on the outer edge 87 of the two plates 64. 65 lying on top of one another. Furthermore, all fluid openings 41, other than the discharge channel 47 of the coolant, are sealed with the sealing means 84. A large vacuum is then generated at the discharge channel 47 for coolant, which is formed by two aligned fluid openings 41 of the first and second plates 64, 65 on the sealing plate 39 using a vacuum pump (not shown). For this purpose, the vacuum pump is connected to a vacuum hose (not shown) and the vacuum hose is brought into fluid-conductive connection with the underside as the outer surface 67 of the first plate 64. The outer surface 67 as the top side of the second plate 65 is fluid-tightly sealed with a sealing means 84. Since the outer edge 87 and the remaining fluid openings 41 are sealed, a strong negative pressure of about 400 mbar is thus generated in the intermediate space 79 and is formed substantially by the channels 14 for coolant. The pressure difference between the ambient pressure and the negative pressure in the intermediate space 79 is thus approximately 600 mbar. The ambient pressure of the air thus applies a substantially constant contact force to on the outside surface 67 of the second plate 65. This contact force is substantially constant per unit area, so that the outer surface 67 of the second plate 65 is advantageously subjected to a constant pressure. The negative pressure in the process intermediate space 82 is smaller than in the intermediate space 79, so that a smaller contact force per unit area acts on the lower outer surface 67 of the first plate 64 than on the upper outer surface 67 of the second plate 65 with respect to the negative pressure in the process intermediate space 82, and the difference therefrom is applied as a compressive force from the first plate 64 to the support plate 80 without taking gravity into account. The contact forces are thus compressive forces. At the contact region 68, the inner surfaces 66 of the first and second plates 64, 65 thus lie on top of one another with additional compressive forces and, due to the size of these additional compressive forces, a technical zero gap of less than 20 μm substantially occurs at the contact regions 68. The weld seams 70 are then produced using the laser 73. Additionally, the first plate 64 mechanically adjoins the support plate 80 via a contact force.

Optionally, before the negative pressure is generated in the intermediate space 79, the intermediate space 79 is flooded with an inert gas, in particular nitrogen or a noble gas, and preferably the inert gas is also constantly conducted through the intermediate space 79 during the generation and maintenance of the negative pressure. This is achieved by, e.g., additionally conducting a small amount of inert gas into and through the supply channel 46 during suction using the vacuum pump at the discharge channel 47 for coolant. Given that it is not technically possible to seal the outer edge 87 and the remaining fluid openings 41 in a completely sealed manner, it is necessary to constantly introduce inert gas into the intermediate space 79 while maintaining the negative pressure, so that inert gas is constantly present in the intermediate space 79 during welding. Moreover, inert gas is constantly supplied to the outside of the focal spot on the outer surface 67 of the second plate 65, i.e., the point of impact of the laser beam 74. As a result, the weld seam 70 can be produced completely with inert gas flushing.

The sealing means 84 for sealing the intermediate space 79 is designed as a film 85 made of plastic. For this purpose, the film 85, which is wound on a roll 86, is unwound from the roll 86 by a robot 89 or manually and placed on the outer surface 67 of the first and/or second plate 64, 65. The film 85 is thereby placed entirely around on the outer edge 87 of the first and/or second plates 64, 65 and additionally at all fluid openings 41, apart from the fluid opening 41 as the discharge channel 47 for the coolant for producing the negative pressure in the intermediate space 79. The film 85 is an adhesion film 85, so the adhesion film 85 adheres to the outer surface 67 with adhesion forces without adhesive. The thickness or wall thickness of the plastic film 85 is sufficiently dimensioned that it reliably fluid-tightly seals the intermediate space 79 from the surroundings during the negative pressure in the intermediate space, i.e., no damage to the film 85 occurs while the negative pressure is maintained in the intermediate space 79. For this purpose, the film 85 has a thickness of about 0.5 mm.

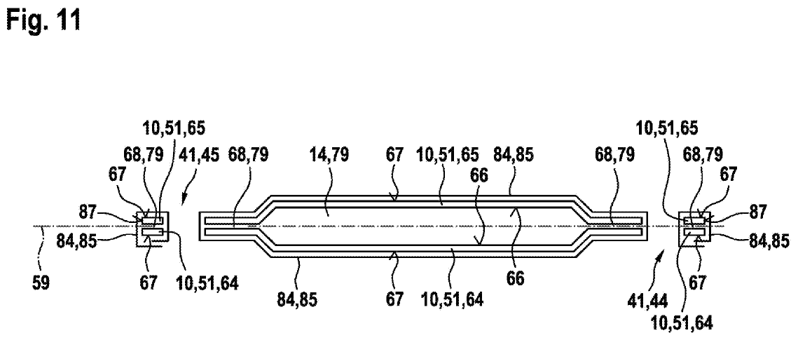

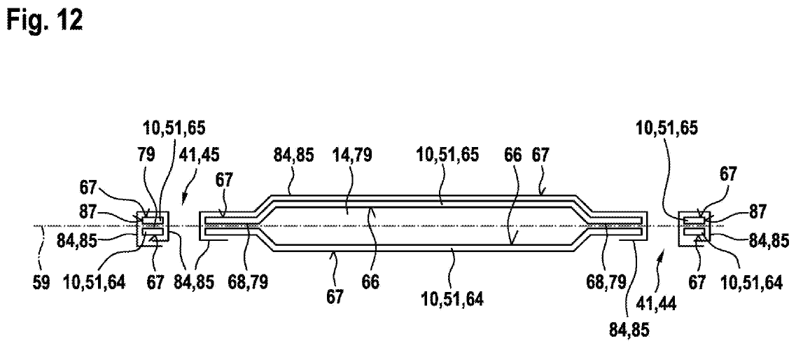

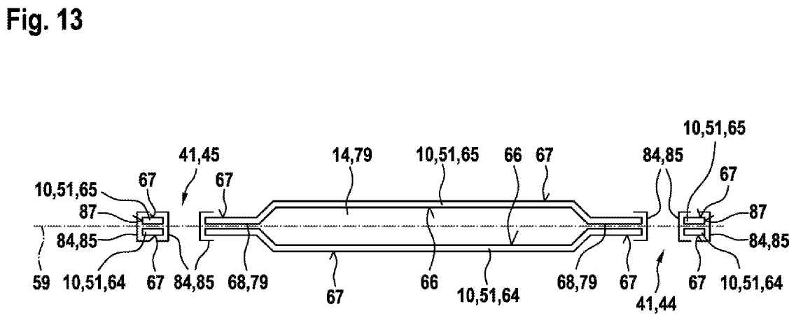

A first exemplary embodiment is shown in FIG. 11 for placing the film 85 on the outer surface 67 of the first and second plates 64, 65. In the first exemplary embodiment shown in FIG. 11, the entire outer surface 67 is covered with the film 85. In the second exemplary embodiment shown in FIG. 12, the entire outer surface 67 is not covered with the film 85. The outer surface 67 of the first plate 64 in the region of the channels 14 for coolant is excluded from the covering with the film 85. In the third exemplary embodiment shown in FIG. 13, the film 85 is only applied to those regions of the outer surface 67 of the first and second plates 64, 65, which are absolutely necessary for sealing the intermediate space 79. These are the outer circumferential edge 87 on the first and second plates 64, 65 and the fluid openings 41.

The film 85 is designed to be translucent. The film 85 can thus also be applied to regions of the outer surface 67 of the second plate 65 where the welded joint connection 69 is produced by the laser beam 74. The laser beam 74 directed at the film 85 penetrates the film 85 and dissolves the film 85 due to the high temperature, i.e., the film 85 melts and/or vaporizes. During the application of the film 85 to the outer surfaces 67 of the first and second plates 64, 65, this method step is simplified because care need not be taken to ensure that no film 85 is applied to regions of the outer surface 67 of the second plate 65 that are exposed to the laser beam 74.

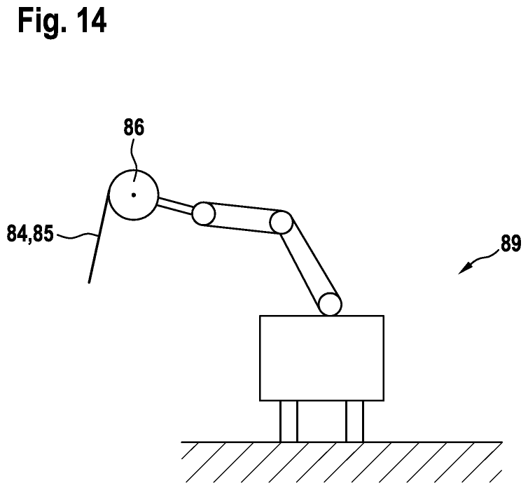

The film 85 can be applied manually or by the robot 89 shown in FIG. 14 to the outer side 67 of the first and second plates 64, 65. In addition, a camera is arranged on the robot 89 or on a further robot 89 (not shown). The color of the film 85 differs significantly from the color of the first and second plates 64, 65, so that the position of the film 85 on the outer surface 67 of the first and second plates 64, 65 can be detected by the camera and a corresponding image processing software in a computer (not shown, and in the actual position). During and after application of the film 85 to the outer surface 67 of the first and second plates 64, 65, it is thus possible to constantly monitor and check whether the film 85 is properly applied to the necessary regions of the outer surface 67 (target position). If faults occur, they can be automatically repaired by the robot 89 and covered with the film 85.

After the manufacture of the welded joints 69, the film 85 is not reused, meaning that it is a disposable product. However, it is necessary for process-related reasons to completely remove the film 85 from the outer surface 67 after the manufacture of the welded joints 69. This removal of the film 85 from the outer surface 67 is performed mechanically and/or pneumatically and/or thermally. In the case of mechanical removal of the film 85, it is removed with, for example, rotating brushes on an arm of the robot 89. When the film 85 is pneumatically removed, it is removed using, e.g., compressed air at a high pressure of, e.g., 40 bar from a nozzle attached to the arm of robot 89. When the film 85 is thermally removed from the outer surface 67 of the first and/or second plate 64, 65, a heating and removal of the film 85 is, e.g., performed locally using a thermal radiator or a gas flame. Preferably, after thermal removal of the film 85 using compressed air, combustion and residual products of the film 85 are removed.

The complete removal of the film 85 from the outer surface 67 of the first and/or second plates 64, 65 can optionally also be additionally verified using the camera and the image processing software. Insofar as the film 85 has not been removed at individual regions, an additional post-processing of the regions detected using the camera and the image processing software can be performed using the remaining film 85.

Overall, the method according to the invention for manufacturing the bipolar plate 10, the method according to the invention for manufacturing the electrochemical cell unit 53, and the electrochemical cell unit 53 according to the invention have significant advantages. The necessary high contact forces at the contact region 68 are generated substantially by means of the negative pressure in the intermediate space 79. Advantageously, it is not then necessary to provide mechanical hold-down devices at the region above the second plate 65. The laser beam 74 can thus be guided across the outer surface 67 of the second plate 65 without obstruction and without activation and deactivation of mechanical hold-down devices. The large number of weld seams 70 between the first plate 64 and the second plate 65 can thus be produced in a very short time, limited only by the speed for producing the weld seams 70. The sealing means 84 as the film 85 can be easily arranged on the outer surface 67 of the first and second plates 64, 65 such that the sealing means 84 has a low cost and a high level of reliability. The film 85 as a disposable product is inexpensive to manufacture and use, and due to the automated method of applying the film 85 using the robot 89, the costs for applying the film 85 are low. As a disposable product, it is therefore not necessary to clean the sealing means 84 as the film 85 after the welded joint 69 has been produced to, e.g., remove any metal deposits due to the production of the welded joint 69. The costs for the manufacture of the bipolar plate 10 are thus low because, on the one hand, no mechanical hold-down devices need be provided and, in addition, the welding operation for the production of the weld seams 70 can be performed in a very short time and thus also very inexpensively.

1. A method for producing a bipolar plate (10, 51) for an electrochemical cell unit (53) for converting electrochemical energy into electrical energy as a fuel cell unit (1) and/or for converting electrical energy into electrochemical energy as an electrolytic cell unit (49) having stacked electrochemical cells (52), said method comprising:
providing a first plate (64) and a second plate (65),
stacking the first plate (64) and the second plate (65), one atop the other, such that inner surfaces (66) of the first and second plate (64, 65) lie one atop the other, and an intermediate space (79) is formed between the first and second plates (64, 65),
fluid-tightly sealing the intermediate space (79) with respect to surroundings using at least one sealing means (84) for preventing the inflow of fluid from the surroundings into the intermediate space (79),
applying contact forces to the first and/or second plate (64, 65) so that, as a result of the applied contact forces, the inner surfaces (66) of the first and second plates (64, 65) lie, one atop the other, with an additional compressive force in a contact region (68) due to the applied contact forces by applying a negative pressure to the intermediate space (79) relative to an ambient pressure, said negative pressure in the intermediate space (79) causing the contact forces applied to the first and/or second plate (64, 65) to be applied to the first and/or second plate (64, 65) by the ambient pressure,
producing a welded joint (69) between the first and second plate (64, 65), wherein
the interior space (79) is sealed using at least one film (85) as the at least one sealing means (84).

2. The method according to claim 1,
wherein
the negative pressure in the intermediate space (79) is at least 100 mbar less than the ambient pressure.

3. The method according to claim 1,
wherein
the first plate (64) is first placed on a support plate (80), and then the second plate (65) is placed on the first plate (64).

4. The method according to claim 1,
wherein
the intermediate space (79) between the first and second plates (64, 65) is sealed using the at least one film (85) relative to the surroundings after placing the second plate (65) on the first plate (64).

5. The method according to claim 1,
wherein
the intermediate space (79) opening into an outer edge (87) of the first and second plates (64, 65) lying one atop the other is sealed using the at least one film (85).

6. The method according to claim 1,
wherein
the intermediate space (79) opening into fluid openings (41) of the first and second plates (64, 65) lying one atop the other is sealed using the at least one film (85).

7. The method according to claim 1,
wherein
the at least one film (85) is placed on at least one outer surface (67) of the stacked first and/or second plate (64, 65).

8. The method according to claim 7
wherein
the at least one film (85) is placed on at least 30% of an area of the at least one outer surface (67) of the stacked first and/or second plate (64, 65).

9. The method according to claim 7
wherein
the at least one film (85) is placed on the at least one outer surface (67) of the stacked first and/or second plate (64, 65) by unwinding the at least one film (85) from a roll (86) and then placing it on the at least one outer surface (67) of the stacked first and/or second plate (64, 65).

10. The method according to claim 1,
wherein
the welded joint (69) is produced by laser welding.

11. The method according to claim 10,
wherein
the at least one film (85) is placed on a region of the at least one outer surface (67) of the first and/or second plate (64, 65), onto which a laser beam (74) emitted by a laser (73) is directed as a focal spot for producing the welded joint (69) such that the at least one film (85) is penetrated and/or dissolved by the laser beam (74) during the production of the welded joint (69) using the laser beam (74).

12. The method according to claim 7,
wherein
the at least one film (85) is removed from the at least one outer surface (67) of the first and/or second plate (64, 65) stacked one atop the other after the production of the welded joint (69).

13. The method according to claim 1,
wherein,
during the production of the welded joint (69), the intermediate space (79) is exposed to negative pressure relative to the ambient pressure.

14. A method for producing an electrochemical cell unit (53) for converting electrochemical energy into electrical energy as a fuel cell unit (1) and/or for converting electrical energy into electrochemical energy as an electrolytic cell unit (49) having stacked electrochemical cells (52), said method comprising:
providing layer-shaped components (5, 6, 7, 8, 9, 10, 30, 51) of the electrochemical cells (52),
stacking the layered components (5, 6, 7, 8, 9, 10, 30, 51) to form electrochemical cells (52) and a stack of the electrochemical cell unit (53),
wherein
the bipolar plates (10, 51) are provided by performing the method according to claim 1.

15. An electrochemical cell unit (53) for converting electrochemical energy into electrical energy as a fuel cell unit (2) and/or for converting electrical energy into electrochemical energy as an electrolytic cell unit (49) comprising:
stacked electrochemical cells (52), and the electrochemical cells (52) each comprise stacked layered components (5, 6, 7, 8, 9, 10, 51), and
the components (5, 6, 7, 8, 9, 10, 51) of the electrochemical cells (52) are proton exchange membranes (5), anodes (7), cathodes (8), gas diffusion layers (9) and bipolar plates (10, 51), wherein a bipolar plate (10, 51) is formed from a first and a second plate (64, 65),
wherein
the electrochemical cell unit (53) is produced by a method according to claim 14 and/or
the first and/or second plates (64, 65) have no clamping markings.

16. The method according to claim 2, wherein the negative pressure in the intermediate space (79) is at least 300 mbar less than the ambient pressure.

17. The method according to claim 16, wherein the negative pressure in the intermediate space (79) is at least 500 mbar less than the ambient pressure.

18. The method according to claim 8, wherein the at least one film (85) is placed on at least 70% of the area of the at least one outer surface (67) of the stacked first and/or second plate (64, 65).

19. The method according to claim 18, wherein the at least one film (85) is placed on at least 90% of the area of the at least one outer surface (67) of the stacked first and/or second plate (64, 65).

20. The method according to claim 19, wherein the at least one film (85) is placed on all of the area of the at least one outer surface (67) of the stacked first and/or second plate (64, 65).
